(19) United States
(12) Patent Application Publication
(10) Pub. No.: US 2019/0232484 A1
(43) Pub. Date: Aug. 1, 2019

(54) TRANSPORTABLE MACHINING UNIT AND STACKING ARRANGEMENT

(71) Applicant: Festool GmbH, Wendlingen (DE)

(72) Inventor: Dominic Richard ENDER, Nürtingen (DE)

(73) Assignee: Fest00l GmbH, Wendlingen (DE)

(21) Appl. No.: 16/339,428

(22) PCT Filed: Oct. 5, 2016
(86) PCT No.: PCT/EP2016/073743

§ 371 Date: Apr. 4, 2019

(51) Int. Cl. B25H 3/02; B23D 47/02

(52) U.S. Cl. CPC B25H 3/021; B25H 3/006; B23D 47/025

(57) ABSTRACT

A transportable machining unit for machining a workpiece with a tool, including a box-shaped support structure placed on a support and having a lower part with a workpiece support plate, and a drive unit for mechanically driving the tool arranged at least partially in the lower part and fastened thereto ready for operation so that the drive unit remains at least partially in the lower part during machining of the workpiece by the tool driven by the drive unit. The support structure has a coupling arrangement suitable for coupling in a state in which the support structure together with at least one box-shaped body forms a vertical stack, to provide a releasable, vertically tension-proof coupling with the at least one box-shaped body.

The invention relates to a transportable machining unit, in particular a circular table saw, for machining a workpiece with a tool, comprising a box-shaped support structure which can be placed on a support and has a lower part which has a workpiece support plate which can be used to support the workpiece to be machined, and a drive unit for mechanically driving the tool, which drive unit is arranged at least partially in the lower part and is fastened thereto ready for operation, so that the drive unit remains at least partially in the lower part when the workpiece is machined by the tool driven by the drive unit.

DE 20 2004 009 123 U1 describes a circular table saw with a housing which is provided with essentially closed outer surfaces on the circumference and underside. The housing carries a worktop with a supporting surface. A machine frame for holding a motor and a saw blade is located below the worktop.

One object of the invention is to improve the manageability of a transportable machining unit of the type mentioned above.

This object is achieved by the features specified in the characterising part of claim 1. According to the invention, the support structure has support structure coupling means adapted to provide a releasable, vertically tension-proof coupling with at least one box-shaped body in a state in which the support structure together with the at least one box-shaped body forms a vertical stack.

By having the support structure coupling means, the transportable machining unit can be stably accommodated in a vertical stack of box-shaped bodies such as box-shaped containers and/or other transportable machining units. The transportable machining unit can therefore be stored in a very practical way.

In addition, the transportable machining unit can be transported efficiently and safely thanks to the support structure coupling means. Since the support structure coupling means are suitable for a vertically tension-proof coupling, a stack comprising the transportable machining unit can be formed, the individual stacking elements of which stack are coupled to each other in a vertically tension-proof manner. In this context, a vertically tension-proof coupling refers in particular to a vertically fixed and force-transmitting connection. The transportable machining unit accommodated in such a stack remains firmly coupled to the other elements of the stack even when the stack is lifted vertically and can therefore be transported in the stack in an efficient and safe manner.

According to the invention, the manageability of the transportable machining unit can thus be improved, in particular with regard to stowage and transport of the transportable machining unit.

The basic shape of the transportable machining unit is defined in particular by the box-shaped support structure. The outer surfaces of the support structure preferably represent the housing or the outer housing surfaces of the transportable machining unit. The housing or the basic shape of the transportable machining unit has the shape of a system casing in particular. System casings of a system have a base area defined in the system and have coupling means defined in the system so that system casings of a system can be assembled into a stable stack. System casings are widely used, for example, as modular tool boxes for storing hand-held power tools, accessories and/or consumables. If the basic shape or the housing of the machining unit according to the invention is in the form of a system casing, the transportable machining unit can be conveniently stowed and transported in a stack of system casings.

The support structure of the transportable machining unit serves several purposes. On the one hand, it defines, as explained above, the basic shape of the transportable machining unit and is designed in such a way that the transportable machining unit can be stored or transported in a stack of other box-shaped bodies or transportable machining units. On the other hand, the support structure provides the workpiece support plate on which the workpiece is placed during machining. Finally, the drive unit, for example an electric motor, is accommodated and fastened ready for operation in the support structure so that the transportable machining unit can be conveniently removed from a stack and put into operation or accommodated in a stack after operation without having to convert the drive unit. The drive unit always remains in a ready-to-operate arrangement in the support structure. In particular, the drive unit remains in a ready-to-operate arrangement in the support structure in both an operating state—i.e. a state in which the transportable machining unit can be used to machine a workpiece—and a transport state—i.e. a state in which the transportable machining unit can be accommodated in a stack. No time-consuming conversions are therefore required between the transport state and the operating state, so that the transportable machining unit can be put into operation quickly and easily.

As mentioned above, the transportable machining unit can be accommodated in a stack of box-shaped bodies due to the support structure coupling means. The box-shaped bodies can, for example, be containers or transportable machining units according to the invention. Box-shaped bodies, which together form a stack, are also referred to here as stacking elements.

Advantageous further developments are the subject matter of the dependent claims.

Preferably, the support structure coupling means comprise upper support structure coupling means adapted to provide a releasable, vertically tension-proof coupling to the box-shaped body in a state in which a box-shaped body is stacked on the transportable machining unit. Alternatively or additionally, the support structure coupling means comprise lower support structure coupling means adapted to provide a releasable, vertically tension-proof coupling with the box-shaped body in a state in which the transportable machining unit is stacked on a box-shaped body.

The transportable machining unit can therefore be arranged in a stack on and/or under a box-shaped body and coupled to it in a vertically tension-proof manner. The support structure coupling means are preferably suitable for providing a locked coupling in several, in particular in all spatial directions.

The support structure coupling elements are in particular configured to be coupled to support structure coupling means of a box-shaped body identical to the support structure coupling elements, when the box-shaped body is arranged on or below the transportable machining unit and forms a stack therewith.

According to a preferred embodiment, the support structure coupling means, preferably the upper support structure coupling means, comprise a movably mounted locking element, which in particular comprises a rotary latch rotatably mounted on the support structure. It is expedient for the axis of rotation to be orthogonal to the circumferential wall of the support structure on which the rotary latch is arranged.

The locking element may, for example, be movably mounted and arranged such that it can be brought into coupling engagement with a locking anchor contour provided on a box-shaped body when in a coupling position when the box-shaped body is placed on or below the transportable machining unit. The locking element is preferably attached to a circumferential wall of the transportable machining unit.

The support structure coupling means may include one or more locking elements.

The locking element can be mounted in a variety of movable positions, e.g. rotatable, swiveling or displaceable. Alternatively or additionally to the already mentioned variant of the locking element as a rotary latch, the locking element can also include a locking lug, which is pivotally movable or slidably mounted. In this case, it is expedient for the pivot axis to run parallel to the circumferential wall of the transportable machining unit on which the locking lug is arranged. It is expedient for the sliding axis of the sliding bearing arrangement to run in a vertical direction.

Using a movably mounted locking element, the transportable machining unit can be coupled to or decoupled from the box-shaped body in a particularly simple manner. If the locking element is designed as a rotatable rotary latch, coupling and uncoupling is possible by turning the rotary latch.

The support structure coupling means, preferably the lower support structure coupling means, expediently comprise at least one locking anchor contour non-movingly arranged on the support structure.

The locking anchor contour can, for example, be designed as at least one locking projection projecting from a circumferential wall of the transportable machining unit. The support structure coupling means may include one or more locking anchor contours or locking projections.

In addition to the locking element and locking anchor contour discussed above, the support structure coupling means may have engagement structures adapted to engage corresponding engagement structures of a box-shaped body such as a container or another transportable machining unit.

In this way, in a state in which the transportable machining unit together with the box-shaped body forms a stack, it is possible to achieve securing the transportable machining unit and the box-shaped body relative to each other in a direction perpendicular to the vertical direction.

Furthermore, the engagement structures can also contribute to vertical coupling. This can be achieved by a locking engagement of reach-behind components of the engagement structures, wherein the locking engagement can be established by a relative movement of the transportable machining unit to the box-shaped body.

Preferably, the upper support structure coupling means comprise a first engagement structure of at least one engagement recess disposed on an upper surface of the support structure and the lower support structure coupling means comprise a second engagement structure of at least one engagement projection disposed on an underside of the support structure. At least one of the engagement projections can, for example, be designed as a stand foot. It is expedient that the at least one stand foot also forms at least partly the reach-behind components discussed above.

According to a preferred embodiment, the support structure comprises a removable upper part attached to the lower part with a frame structure extending vertically upwards over the workpiece support plate.

The frame structure together with the workpiece support plate defines a storage space and thus provides a storage option for accessories. In the operating state of the transportable machining unit, the upper part can be removed from the lower part to make the workpiece support plate and the tool more accessible. When the transportable machining unit is in the transport state, the upper part is attached to the lower part in order to provide the storage space.

According to a possible embodiment, the frame structure represents the upper part.

Upper part coupling means are expediently provided on the upper part and lower part coupling means are provided on the lower part, which can be brought into coupling engagement with each other to provide a vertically tension-proof coupling between the upper part and lower part. The upper part coupling means and the lower part coupling means comprise, for example, a movable locking element and/or a locking anchor contour.

Preferably, the horizontal cross-section of the upper part, preferably the horizontal cross-section of the frame structure, has essentially the same outer contour as the horizontal cross-section of the lower part. The upper part and lower part or frame structure and lower part together form a box-shaped body.

The tool is expediently attached to the drive unit and at least partially arranged above the workpiece support plate. Preferably, the frame structure extends upwards in the vertical direction beyond the tool attached to the drive unit.

As the frame structure extends vertically upwards beyond the tool attached to the drive unit, the transportable machining unit can be stacked under a box-shaped body without removing the tool. The frame structure serves in particular to create the necessary space in the vertical direction in order to be able to leave the tool, which is at least partially arranged above the workpiece support plate, at the drive unit even in the transport state. In this way, the tool can remain in an arrangement ready for operation even during transport.

The upper support structure coupling means are provided in particular on the upper part. Alternatively or additionally, the lower support structure coupling means are provided on the lower part.

According to a preferred embodiment, the upper part is designed as a hood-shaped cover that covers the workpiece support plate when attached to the support structure.

Preferably, the frame structure and the workpiece support surface together delimit a storage space. In particular, the upper part has a removable and/or pivoting lid attached to the frame structure which, in an open position, gives access to the storage space.

The transportable machining unit is expediently equipped with a carrying handle which is provided on the support structure, preferably on the upper part, in particular on the cover. In particular, the support structure is designed so that the transportable machining unit can be carried with the carrying handle.

A stack assembly is further provided comprising a transportable machining unit described above and at least one box-shaped body disposed on or below the transportable machining unit to form a vertical stack together with the transportable machining unit, wherein the box-shaped body has body coupling means cooperating with the support structure coupling means to provide a releasable, vertically tension-proof coupling between the box-shaped body and the transportable machining unit.

According to a preferred embodiment, the box-shaped body is a container or another machining unit as described above. In the latter case, the body coupling means represent the support structure coupling means.

Preferably, the horizontal cross-section of the transportable machining unit has essentially the same outer contour as the horizontal cross-section of the box-shaped body. In particular, the transportable machining unit is aligned with the box-shaped body so that the transportable machining unit and the box-shaped body together form a cuboid stack.

An exemplary embodiment of a transportable machining unit is explained below with reference to the drawing. Wherein:

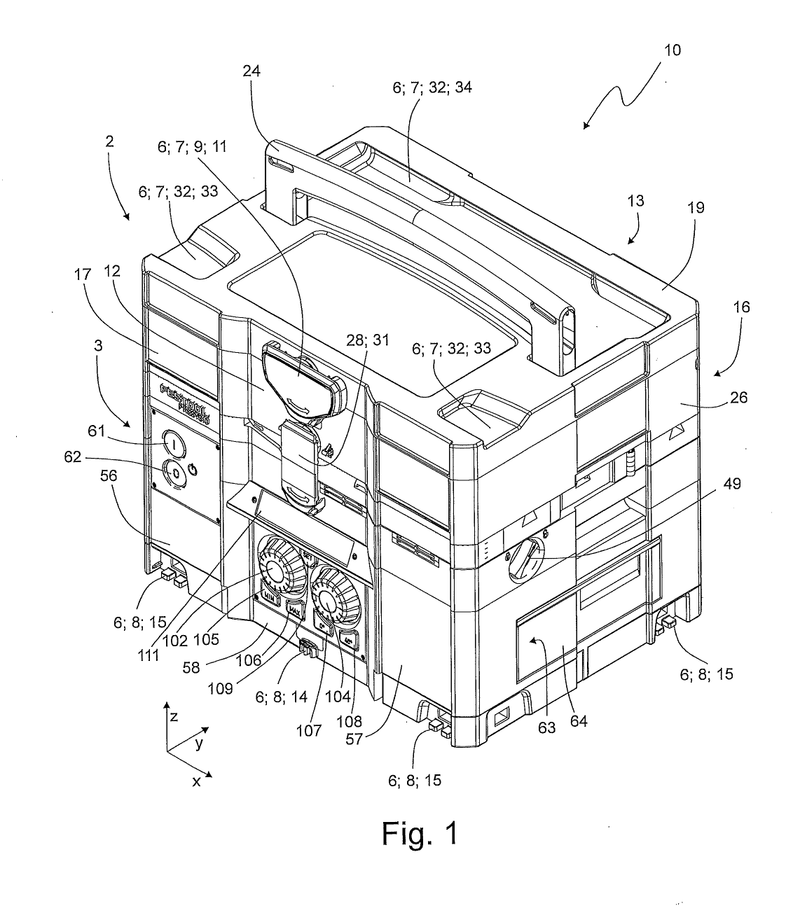

FIG. 1 shows a perspective representation of a transportable machining unit;

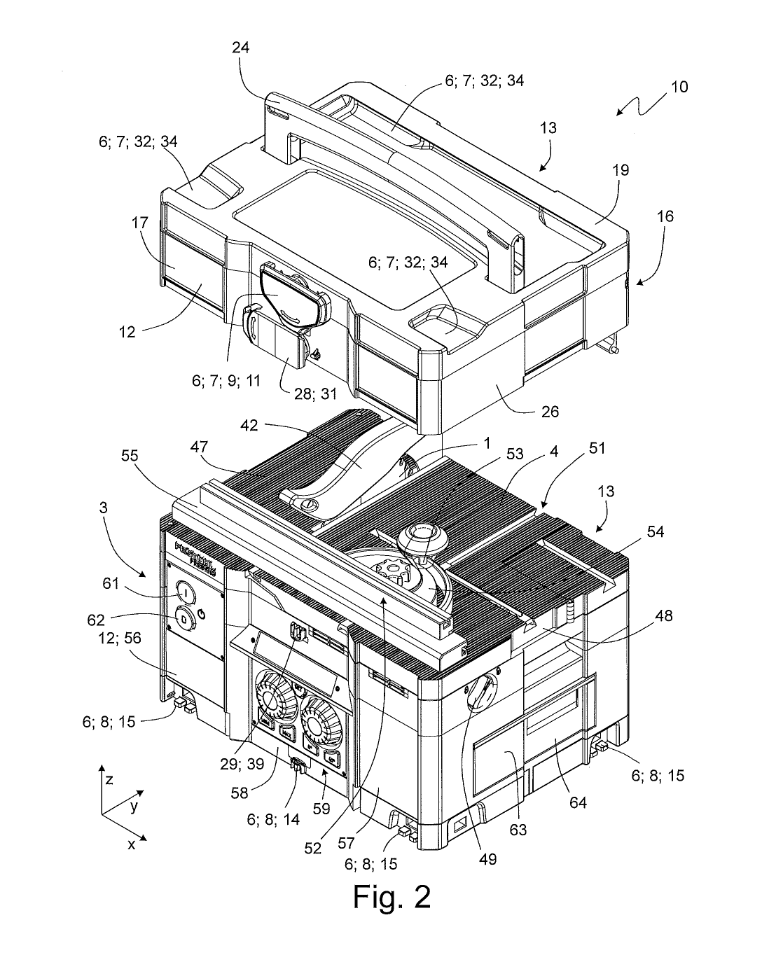

FIG. 2 shows a perspective representation of the transportable machining unit from the front with the upper part detached;

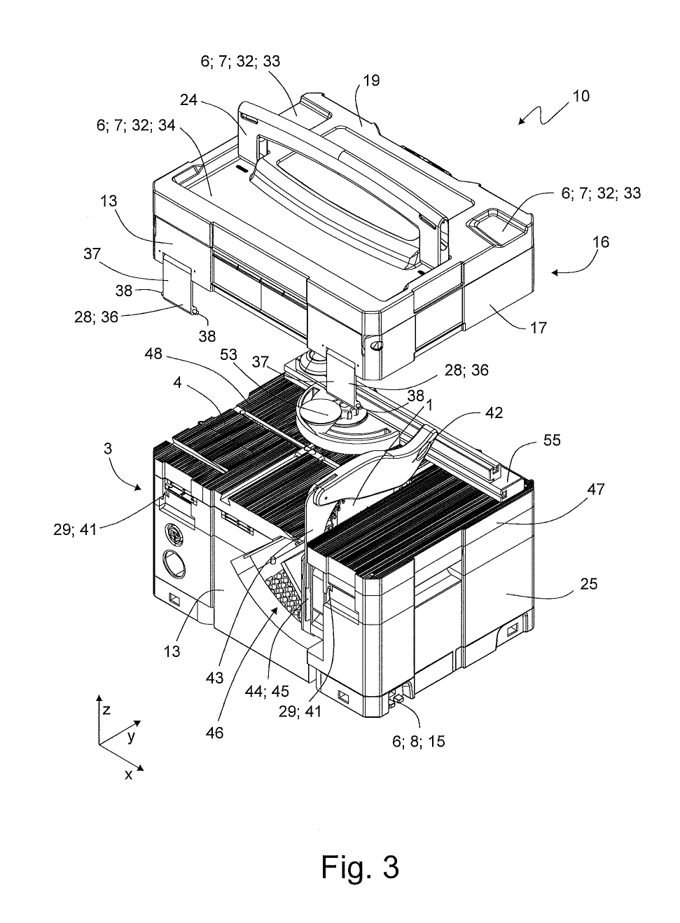

FIG. 3 shows a perspective representation of the transportable machining unit from behind with the upper part detached;

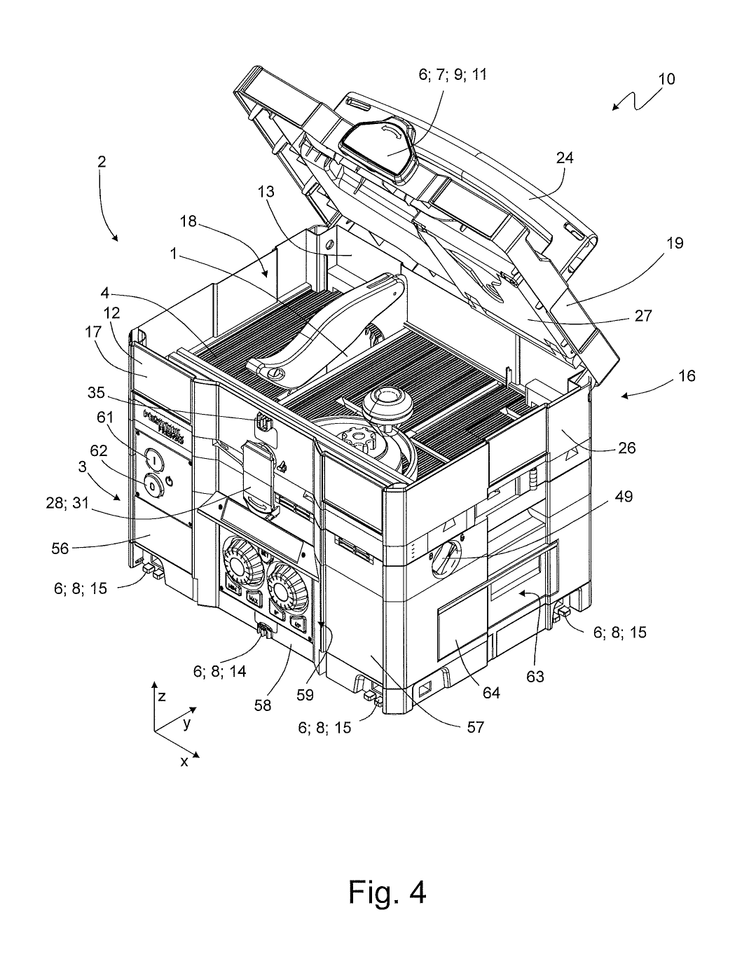

FIG. 4 shows a perspective representation of the transportable machining unit with the cover open;

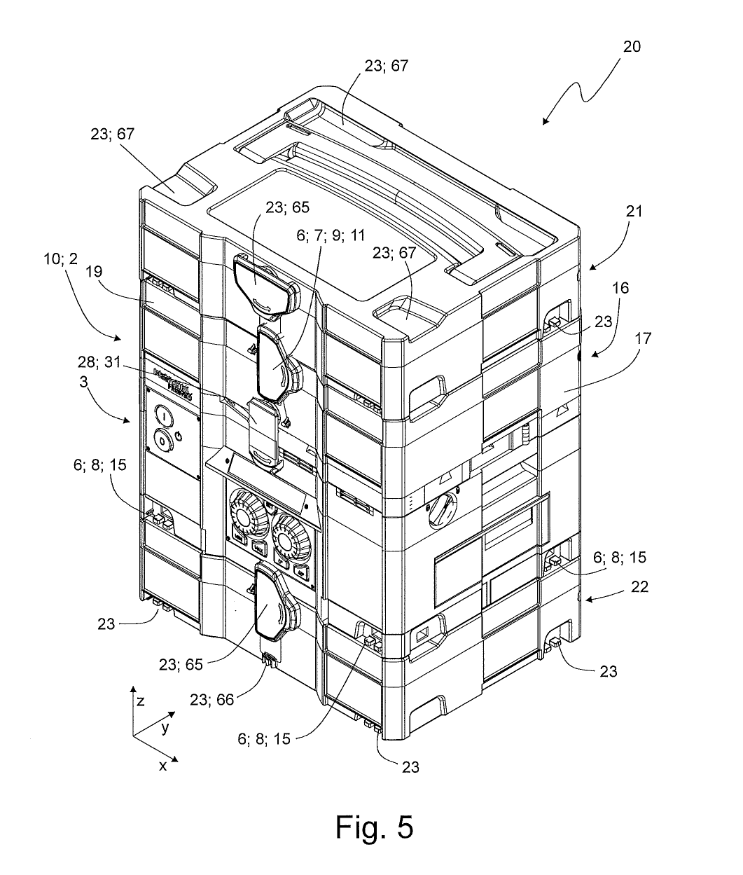

FIG. 5 shows a perspective representation of a stack arrangement from the transportable machining unit and two box-shaped containers;

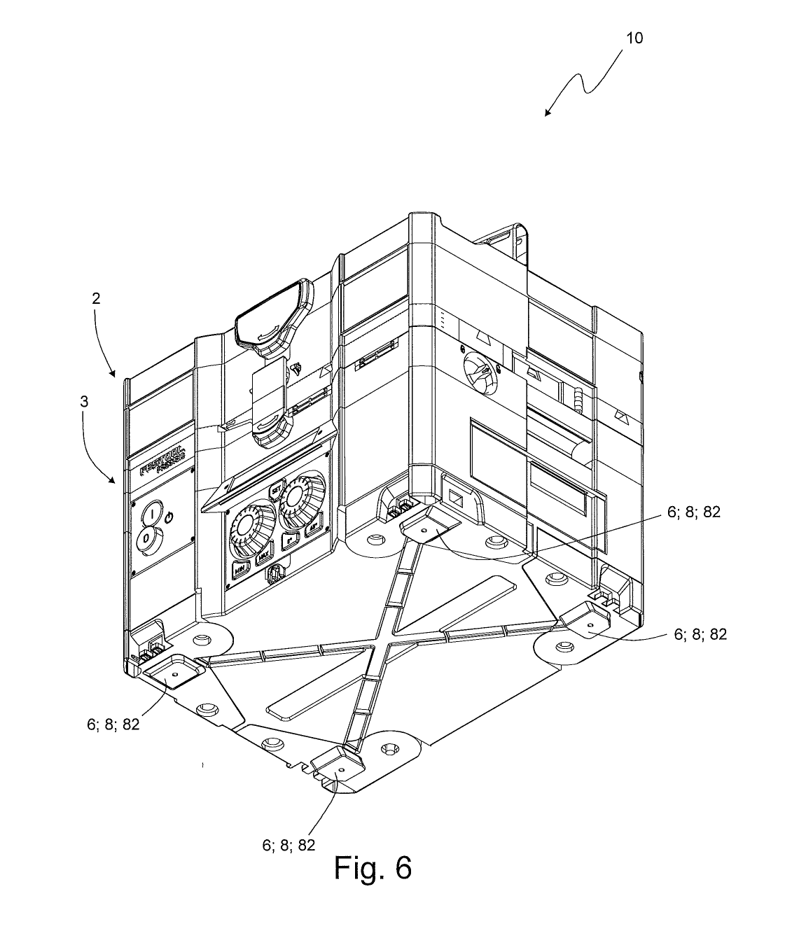

FIG. 6 shows a perspective view of the transportable machining unit from below;

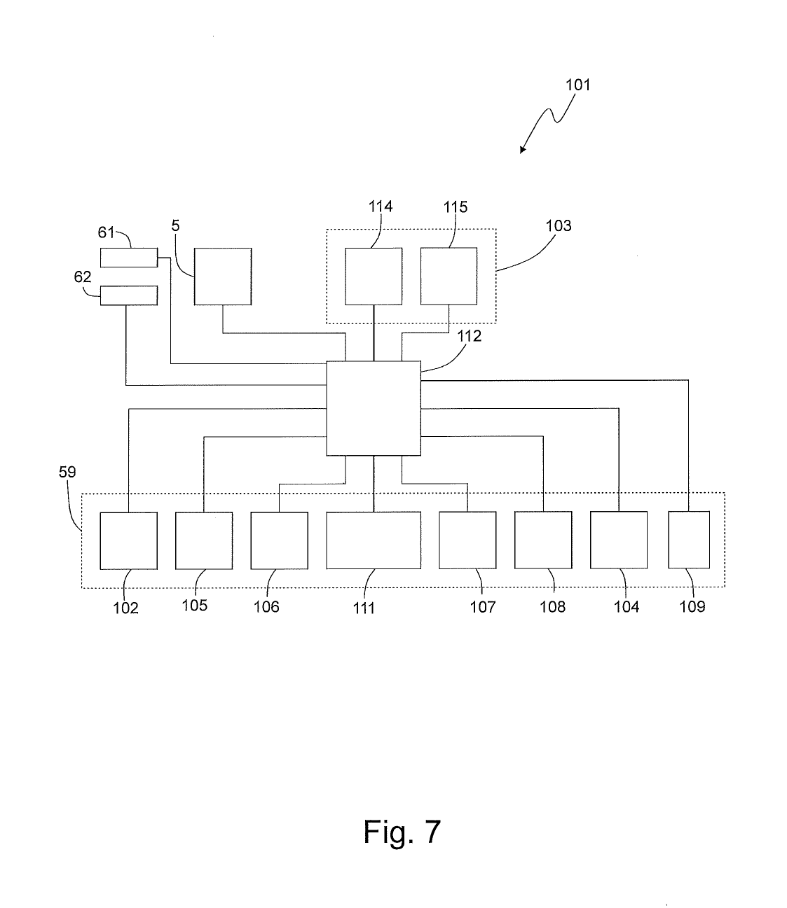

FIG. 7 shows a schematic block diagram of a control unit 101.

FIGS. 1 to 4 and 6 show perspective representations of a transportable machining unit 10. FIG. 5 shows a stack arrangement 20 in which the transportable machining unit 10 is accommodated.

The transportable machining unit 10 extends in a vertical direction parallel to the z-axis drawn in the figures, in a longitudinal direction parallel to the x-axis drawn in the figures, and in a transverse direction parallel to the y-axis drawn in the figures. The x-axis, y-axis and z-axis are orthogonal to each other.

In the figures shown, the transportable machining unit 10 is designed as a circular table saw. Alternatively, the transportable machining unit 10 can also be designed as another semi-stationary machine, such as a router, scroll saw or edge grinder. In this context, a semi-stationary machine is defined in particular as a machining unit which is placed on a support during workpiece machining and which can be carried by one person during transport.

The transportable machining unit 10 is used to machine a workpiece not shown in the figures with a tool 1. The tool 1 in the figures is exemplarily designed as a saw blade.

The transportable machining unit 10 comprises a box-shaped support structure 2, which can be placed on a support, with a lower part 3, which has a workpiece support plate 4, which can be used to support the workpiece to be machined. The box-shaped support structure 2 is an essentially cuboid structure in which the outer surfaces, preferably all outer surfaces, are essentially closed.

Furthermore, the transportable machining unit 10 includes a drive unit 5, which is shown schematically in FIG. 7. The drive unit 5, for example, comprises an electric motor for the mechanical drive of the tool 1. In the example discussed, the drive unit 5 is completely arranged in the lower part 3 and fastened to the lower part 3 ready for operation, so that the drive unit 5 remains in the lower part 3 when the workpiece is machined by the tool 1 driven by the drive unit 5.

The support structure 2 has support structure coupling means 6. The support structure coupling means 6 are adapted to provide a releasable, vertically tension-proof coupling with the at least one box-shaped body in a state in which the support structure 2 together with at least one box-shaped body 21, 22 forms a vertical stack.

The transportable machining unit 10 can be stably accommodated in a stack of box-shaped bodies 21, 22, such as box-shaped containers and/or further transportable machining units 10 due to the support structure coupling means 6. The transportable machining unit 10 can therefore be very conveniently stowed in the stack and/or transported safely. The transportable machining unit 10 according to the invention therefore offers improved manageability.

As can be seen in the figures, the transportable machining unit 10 has in particular the basic shape of a system casing. The transportable machining unit 10 shown in the figures is designed to be accommodated in a stack of further system casings, as shown in FIG. 5 for example.

Exemplary configurations of the transportable machining unit 10 are explained in detail below.

The support structure 2 is box-shaped and has four circumferential walls aligned orthogonally to each other. The circumferential walls comprise a front wall 12, a rear wall 13, as well as side walls 25 and 26. The front wall 12 and the rear wall 13 are aligned parallel to the longitudinal direction x, and the side walls 25, 26 are aligned parallel to the transverse direction y.

The support structure 2 of the transportable machining unit 10 shown in the figures has an upper part 16 detachably attached to the lower part 3. FIG. 1 shows the machining unit 10 in a state in which the upper part 16 is placed on and coupled to the lower part 3. FIG. 2 shows the transportable machining unit 10 in a state in which the upper part 16 is detached from the lower part 3.

As an alternative to the embodiment shown, the transportable machining unit 10 can also be designed without upper part 16. In this case the lower part 3 can expediently represent the whole support structure. The support structure coupling means 6 can then all be provided on the lower part 3.

The support structure coupling means 6 comprise upper support structure coupling means 7, which are exemplarily provided on the upper part 16. The upper support structure coupling means 7 are adapted to provide a releasable, vertically tension-proof coupling with the box-shaped body 21 in a state in which a box-shaped body 21 is stacked on the transportable machining unit 10. The upper support structure coupling means 7 comprise a movably mounted locking element 9. In the example shown, the locking element 9 comprises a rotary latch 11 rotatably mounted on the support structure 2. The rotary latch 11 is arranged on the front wall 12 of the support structure 2. The axis of rotation of the rotary latch 11 is orthogonal to the front wall 12.

The support structure coupling means 6 further comprise lower support structure coupling means 8 provided on the lower part 3. The lower support structure coupling means 8 are adapted to provide a releasable, vertically tension-proof coupling to a box-shaped body 22 in a state in which the transportable machining unit 10 is stacked on the box-shaped body 22. The lower support structure coupling means 8 comprise at least one first locking anchor contour 14 non-movably arranged on the support structure 2. In the example shown, the first locking anchor contour 14 is arranged on the lower part 3 of the support structure 2. The first locking anchor contour 14 is located on the front wall 12 of support structure 2 and is arranged centrally on support structure 2 in relation to the longitudinal direction x. The first locking anchor contour 14 is designed as a locking projection and projects from the front wall 12.

The locking element 9 and the first locking anchor contour 14 are arranged in such a way that when two transportable machining units 10 are stacked vertically one above the other, the locking element 9 of one transportable machining unit 10 can be brought into coupling engagement with the first locking anchor contour 14 of the other machining unit 10.

In the example shown, the lower support structure coupling means 8 have second locking anchor contours 15 in addition to the first locking anchor contour 14. The second locking anchor contours 15 are also designed as locking projections, but in contrast to the first locking anchor contour 14 they are arranged in the lower corner areas of the front wall 12 and in the lower corner areas of the side walls 25 and 26 located at the rear wall 13. The second locking anchor contours 15 are used to connect the transportable machining unit 10 to containers or other objects that have locking elements complementary to the second locking anchor contours 15. If it is not provided that the transportable machining unit 10 is also to be coupled to such containers or objects, the second locking anchor contours 15 can also be dispensed with.

The support structure coupling means 6 also comprise engagement structures of the type mentioned at the beginning.

Thus, the upper support structure coupling means 7 further comprise a plurality of engagement recesses 32 distributed on the upper side of the support structure 2. The engagement recesses 32 comprise two first engagement recesses 33 arranged near the front wall 12 and a second engagement recess 34 arranged near the rear wall 13.

The lower support structure coupling means 8 comprise four engagement projections 82 designed as stand feet, which are arranged in the four corner areas of the underside of the support structure 2. The engagement projections 82 can be seen, for example, in FIG. 6. The engagement projections 82 and the engagement recesses 33, 34 are arranged in such a way that with two transportable machining units 10 stacked vertically one above the other, the engagement projections 82 of the upper transportable machining unit engage with the engagement recesses 32 of the lower machining unit.

The engagement projections 82 and the engagement recesses 32 also contribute to the vertical coupling. This can be done by a locking engagement of the reach-behind components of the engagement projections 82 and/or engagement recesses 32, as described in detail in EP2315701B1, for example. For example, the second engagement recess 34 may have an undercut cross-section and the corresponding engagement projections 82 engaging in the second engagement recess 34 may have a correspondingly profiled, for example wedge-shaped, reach-behind section.

The upper part 16 of the support structure 2 is designed as a hood-shaped cover. In the state shown in FIG. 1, for example, the upper part 16 completely covers the workpiece support plate 4. The upper part 16 comprises a frame structure 17 extending vertically upwards over the workpiece support plate 4. The horizontal cross-section of the upper part 16 or the frame structure 17 has essentially the same outer contour as the horizontal cross-section of the lower part 3. The upper part 16 is aligned with the lower part 3, so that together with the lower part 3 it forms the box-shaped support structure 2.

As shown in FIG. 4, the frame structure 17 essentially has the shape of a cuboid jacket surface; i.e. the frame structure 17 has four orthogonally aligned circumferential walls and has an open underside and an open upper side. The frame structure 17 and the workpiece support surface 4 together delimit a storage space 18.

The upper part 16 has a cover 19, which is assigned to the open upper side of the frame structure 17. The cover 19 can be moved to a closed position to close the upper part 16 as shown in FIGS. 1 to 3 and 5, or to an open position to open the upper part and allow access to the storage space 18 as shown in FIG. 4. The cover 19 is pivotable mounted on the frame structure 17 in the area of the rear wall 13. The cover 19 sits completely on the frame structure 17. The outer contour of the horizontal cross-section of the cover 19 corresponds to the outer contour of the horizontal cross-section of the frame structure 17. The upper outer surface of the cover 19 represents the upper side of support structure 2.

The above-mentioned locking element 9, designed for example as an rotary latch 11, is attached to the cover 19.

In the embodiment under discussion, the locking element 9 serves not only to provide a vertically tension-proof coupling between the support structure 2 and a stacking element placed on the support structure 2, but also to lock the cover 19 in such a way that it cannot be moved into the open position. For this purpose, the locking element 9 is designed as a T-shaped rotary latch 11, which can be moved into at least three different positions.

FIG. 4 shows a first position of the rotary latch 11 in which the T-shaped rotary latch 11 is not in coupling engagement with a locking anchor contour 35 arranged below the rotary latch 11 on the frame structure 17. In this position the cover 19 can be opened. Furthermore, a coupling to a stacking element (not shown in FIG. 4) mounted on the transportable machining unit 10 can be provided in this position.

FIG. 2 shows a second position of the rotary latch 11 in which the rotary latch 11 is in coupling engagement with the locking anchor contour 35 arranged on the frame structure 17, but not in coupling engagement with a stacking element (not shown in FIG. 2) when mounted on the transportable machining unit 10. In the second position, the cover 19 is locked and a stacking element placed on the transportable machining unit 10 is decoupled and can be removed.

FIG. 5 shows a third position of the rotary latch 11, in which the rotary latch 11 is simultaneously in coupling engagement with the locking anchor contour 35 provided on the frame structure 17 and with a locking anchor contour provided on an attached stacking element (here the box-shaped container 21). In the third position, the cover 19 is locked and a stacking element placed on the transportable machining unit 10 (here the box-shaped container 21) is coupled to it.

A carrying handle 24 is also provided on the cover 19. In the example shown, the carrying handle 24 is located on the upper side of the cover 19. The carrying handle 24 is advantageously designed in such a way that it can either take up a non-use position pivoted towards the upper side of the cover 19 or take up a use position pivoted upwards and thus projecting upwards beyond the upper side. It is preferably a bow-shaped handle with a U-shaped design.

The support structure 2 is designed in such a way that the transportable machining unit 10 can be carried with the carrying handle 24. In particular, the upper part 16 is coupled to the lower part 3 in a vertically tension-proof manner so that when the upper part 16 is lifted with the aid of the carrying handle 24, the lower part 3 is also lifted and remains stable on the upper part 16. In the example shown, in particular the cover 19 can be coupled vertically to the frame structure 17 in a tension-proof manner, and the frame structure 17 can be coupled vertically to the lower part 3 in a tension-proof manner. It is expedient that the frame structure 17 is coupled to the lower part 3 in a tension-proof manner in all spatial directions and/or that the cover 19 is coupled to the frame structure 17 in a tension-proof manner in all spatial directions.

On the underside of the cover 19 there is a storage arrangement 27 for storing a replacement tool, such as a replacement saw blade. Alternatively or additionally, a storage arrangement for accessories, such as a storage arrangement for a splitting wedge on the underside of the cover 19, may also be provided. In the example shown, the storage arrangement 27 has a flat rectangular basic shape and is pivotally hinged to the underside of the cover 19 near the rear wall 13.

As shown in FIGS. 2 to 4, the tool 1, which is designed as a saw blade as an example, is partially arranged above the workpiece support plate 4. The tool 1 reaches through an opening in the workpiece support plate 4 so that part of the tool 1 is above the workpiece support plate 4. Below the workpiece support plate 4, the tool 1 is attached to or coupled with the drive unit 5 so that it can be driven by the drive unit 5.

The frame structure 17 extends vertically upwards beyond the tool 1 attached to the drive unit 5. In this way, the tool 1 can remain on the drive unit 5 even if the transportable machining unit 10 is arranged in a stack and the cover 19 is closed.

The upper part 16 has upper part coupling means 28 and the lower part 3 has lower part coupling means 29. With the aid of the upper part coupling means 28 and the lower part coupling means 29, the upper part 16 can be detachably coupled to the lower part 3 in a vertically tension-proof manner. In particular, the upper part coupling means 28 and the lower part coupling means 29 can form a hinge arrangement.

In the figures, the upper part coupling means 28 comprise, as an example, a movably mounted locking element 31 mounted on the front 12 of the support structure 2 and designed as a rotary latch as an example. The rotary latch is mounted so that it can rotate around a turning axis orthogonal to the front wall 12. As an example, the rotary latch is essentially rectangular and arranged parallel to the front wall 12. The upper part coupling means 28 also include, by way of example, two flaps 36 hinged to the rear wall 13. The lugs 36, for example, each have a flat rectangular base body 37 aligned perpendicular to the transverse direction, at the lower edge of which bearing extensions 38 aligned parallel to the longitudinal direction are provided.

The lower part coupling means 29 comprise an exemplary locking anchor contour 39 on the front wall 12 on the lower part 3. The locking anchor contour 39 projects vertically from the front wall 12 and is arranged in such a way that, in a state in which the upper part 16 is placed on the lower part 3, the locking element 31 can be brought into coupling engagement with the locking anchor contour 39 when taking a coupling position.

The lower part coupling means 28 further include reception arrangements 41 on the lower part 3. The reception arrangements 41 are arranged on the rear wall 13 of the support structure 2. The reception arrangements 41 are designed in such a way that the bearing extensions 38 can be hooked into the reception arrangements 41 for coupling the upper part 16 to the lower part 3. By means of the lugs 36 and the reception arrangements 41, a hinge arrangement with two pivot axes spaced from each other in the vertical direction z and aligned in the longitudinal direction x can be formed. With the hinge arrangement, the upper part 16 can be coupled vertically to the lower part 3 in a tension-proof manner at least in the area of the rear wall 13.

As mentioned above, the tool 1, which is exemplarily designed as a saw blade, reaches through an opening provided in the workpiece support plate 4. The saw blade is aligned parallel to the transverse direction or parallel to the side walls 25, 26 of the support structure 2. The saw blade is covered by a protective hood 42. The protective hood 42 is attached to a splitting wedge 43 which passes through the opening and is attached to a fastening device 44 located below the workpiece support plate 4. A saw blade and/or splitting wedge 42 are preferably accessible through an opening 46 provided in the rear panel 13 on the lower part 3 and can be replaced, for example, by using a quick-release system 45.

The upper side of the workpiece support plate 4 is provided with grooves in the example shown. Alternatively, the upper side of the workpiece support plate 4 can also be provided without grooves or even or with a different structure.

The saw blade lies on an imaginary line running in the transverse direction y, which divides the workpiece support plate 4 in longitudinal direction into two plate sections 47 and 48. The saw blade is preferably arranged eccentrically in the longitudinal direction to the workpiece support plate 4, so that the second plate section 48 is longer than the first plate section 47. For example, the second plate section 48 can be approximately twice as long in the longitudinal direction as the first plate section 47. Preferably, the first plate section 47 is fixed relative to the tool 1, while the second plate section 48 is mounted so as to be displaceable at least in the transverse direction y, so that it can be displaced relative to the tool 1 in the transverse direction y. With the movable second plate section 48, a workpiece can be guided or moved relative to the tool 1 during machining. Using a locking device (not shown), the second plate section 48 can be fixed relative to the tool 1 or the lower part 3. The fixing can be adjusted, for example, by means of a rotary knob 49 provided on the side wall 26 on the lower part 3.

The second plate section 48 can in particular be fixed in a transport position in which it is aligned with the lower part 3 or the upper part 16. The second plate section 48 is shown in the transport position in the drawings. In particular, in the transport position, the horizontal cross-section of the workpiece support plate 4 has essentially the same outer contour as the horizontal cross-section of the lower part 3 and/or the upper part 16.

In the second plate section 48 a groove arrangement 51 is provided in which a stop device 52 can be guided. The stop device 52, for example, is designed as an angular stop and comprises in particular a fastening element 53 which can be guided in the groove arrangement 51, an angular element 54 which can be pivoted relative to the fastening element 53 and a guide rail 55 attached to the angular element 54. The stop device 52 is dimensioned such that it fits into the storage space 18, in particular in a state in which the stop device 52 is guided in the groove arrangement 51.

The front wall 12 of the support structure 2 has two side wall sections 56 and 57 in the longitudinal direction x as well as a central wall section 58 which is offset to the rear in relation to the side wall sections 56, 57—i.e. in the transverse direction y towards the rear wall 13—so that the front wall 12 has, in the longitudinal direction x in the middle, a recess in the transverse direction y. In the example shown, the recess extends over the entire vertical area of the front wall 12 from the underside of the support structure 2 to the upper side and thus over the lower part 3 and the upper part 16. The locking elements 11, 31 discussed above as well as the locking anchor contours 14, 35, 39 are preferably provided on the middle wall section 58 or in the discussed recess as shown in the drawings.

In addition, an operating device 59 is provided at the middle wall section 58. The operating device 59 is located on the lower part 3 and preferably has rotary wheels 102, 104 and/or keys 105, 106, 107, 108 for setting parameters for the operation of the transportable machining unit 10. If, as in the example shown, the transportable machining unit 10 is a circular table saw, the operating device 59 can be used, for example, to adjust the height and/or angle of the saw blade. In particular, the operating device 59 is dimensioned in such a way that it does not project transversely beyond the side wall sections 56, 57.

On the front wall 12 there is a switching device with a switch-on button 61 and a switch-off button 62. In the example shown, the switching device is provided on the side wall section 56. The switching device is arranged on the lower part 3. The switch-off button 62 can preferably be put into two different positions—a transport position, in which the switch-off button 62 is arranged recessed in the front wall 12 or flush with the front wall 12, and an emergency stop position (not shown in the figures), in which the switch-off button 62 extends transversely forwards from the front wall 12 or projects transversely from the front wall. In the emergency stop position, the switch-off button 62 can be easily found and operated, thus serving as an emergency stop switch. Consequently, there is no need for an additional dedicated emergency stop switch. In particular, the switching device is designed in such a way that the switch-off button 62 assumes the emergency stop position when the switch-on button 61 is pressed. The switching device 62 is also expediently designed in such a way that the switch-off button 62 can be put into the transport position by strong pressing, and that strong or light pressing causes the transportable machining unit 10 or its drive unit 5 to be switched off.

A receiving chamber 63 in the lower part 3 leads out on the side wall 26, in which receiving chamber 63 a collecting container 64 is arranged. Through a pipe arrangement (not shown in the figures), dust generated at the tool 1 or material removed from the workpiece can be led into the collection container 64. As the collection container 64 is directly accessible from the outside, it can be emptied particularly easily.

FIG. 5 shows an example of how the transportable machining unit 10 is arranged in a stack with two further box-shaped bodies 21, 22.

The stack arrangement 20 shown in FIG. 5 comprises the transportable machining unit 10 discussed above, an upper box-shaped body 21 arranged on the transportable machining unit 10, and a lower box-shaped body 22 arranged below the transportable machining unit 10. The two box-shaped bodies 21, 22 in FIG. 5 are exemplarily designed as box-shaped containers. Alternatively, each of the box-shaped bodies 21, 22 can also be designed as an additional machining unit 10.

The two box-shaped bodies 21, 22 together with the transportable machining unit 10 form a vertical stack. The box-shaped bodies 21, 22 have body coupling means 23 which cooperate with the support structure coupling means 6 to provide a releasable, vertically tension-proof coupling between the box-shaped bodies 21, 22 and the transportable machining unit 10.

The horizontal cross-section of the transportable machining unit 10 has essentially the same outer contour as the horizontal cross-section of the box-shaped bodies 21, 22. The transportable machining unit 10 is arranged in alignment with the box-shaped bodies 21, 22, so that the transportable machining unit 10 and the box-shaped bodies 21, 22 together form an essentially cuboid stack.

The body coupling means 23 may be identical to the support structure coupling means 6. The coupling between the body coupling means 23 and the support structure coupling means 6 can then be carried out in the same way as the coupling described above between support structure coupling means 6 of two transportable machining units 10.

In particular, the body coupling means 23 comprise a locking element 65, preferably in the form of a rotary latch, a locking anchor contour 66, and engagement structures 67.

FIG. 5 shows the locking anchor contour 66 of the upper box-shaped body 21, placed on the transportable machining unit 10, in coupling engagement with the locking element 9 of the transportable machining unit 10. The locking element 9 of the transportable machining unit 10 is also in coupling engagement with the locking anchor contour 35 of the transportable machining unit 10. The locking element 31 provided on the upper part 16 is in coupling engagement with the locking anchor contour 39 provided on the lower part 3. The locking anchor contour 14 of the transportable machining unit 10 is in coupling engagement with the locking element 65 of the lower box-shaped body 22.

Furthermore, in the exemplary stacking arrangement 20, the above-mentioned engagement structures contribute to the coupling between the transportable machining unit 10 and the box-shaped bodies 21, 22. In particular, the upper box-shaped body 21 has engagement projections on its underside which correspond to the above-mentioned engagement projections 82 of the transportable machining unit 10 and which engage in the engagement recesses 32 of the transportable machining unit 10. Furthermore, the lower box-shaped body 22 has engagement recesses on its upper side which correspond to the above-mentioned engagement recesses 32 of the transportable machining unit 10 and which engage the engagement projections 82 of the transportable machining unit 10.

FIG. 7 shows a schematic block diagram of a control unit 101 that can be integrated in the transportable machining unit 10.

The control device 101 comprises the operating device 59 discussed above and the drive unit 5, as well as a control unit 112 and an electrical actuator 103. Furthermore, the control device 101 may comprise the switch-on button 61 discussed above and the switch-off button 62.

The operating device 59 comprises a plurality of control elements. For example, the operating device 59 comprises a first rotary wheel 102 and a second rotary wheel 104. In addition, the operating device 59 comprises the quick selection buttons 105, 106, 107 and 108, a calibration key 109 and a display 111.

The control unit 112 is, for example, designed as a microcontroller. The operating device 59 or its operating elements are connected to the control unit 112. In addition, the drive unit 5 and electrical actuator 103 are connected to the control unit 112 as examples. In addition, the switch-on button 61 and the switch-off button 62 can also be connected to the control unit 112.

The electrical actuator 103 comprises, as an example, a linear drive 114 and a pivot drive 115, which are designed to position the tool 1 relative to the workpiece support plate 4 according to a control by the control unit 112. The position of the tool 1 can, for example, be set using the turning wheels 102, 104 and/or the quick selection buttons 105, 106, 107 and 108.

The drive unit 5, for example, is designed as an electric motor, in particular as a rotary drive, and serves to mechanically drive the tool 1. The drive unit 5 is attached to the lower part 3 ready for operation, so that the drive unit 5 remains in the lower part 3 when the workpiece 1 is machined by the tool 1 driven by the drive unit 5. The driving of the tool 1 by the drive unit can, for example, be started by pressing the switch-on button 61 and stopped by pressing the switch-off button 62.

1. Transportable machining unit for machining a workpiece with a tool, comprising a box-shaped support structure which can be placed on a support and has a lower part which has a workpiece support plate which can be used to support the workpiece to be machined, and a drive unit for mechanically driving the tool, which is arranged at least partially in the lower part and is fastened thereto ready for operation, so that the drive unit remains at least partially in the lower part during machining of the workpiece by the tool driven by the drive unit, wherein the support structure has support structure couplers adapted to be coupled in a state in which the support structure together with at least one box-shaped body forms a vertical stack, to provide a releasable, vertically tension-proof coupling with the at least one box-shaped body.

2. Transportable machining unit according to claim 1, wherein the support structure couplers comprise upper support structure couplers adapted to provide a releasable vertically tension-proof coupling with the box-shaped body in a state in which a box-shaped body is stacked on the transportable machining unit, and/or the support structure couplers comprise lower support structure couplers adapted, in a state in which the transportable machining unit is stacked on a box-shaped body, to provide a releasable vertically tension-proof coupling with the box-shaped body.

3. Transportable machining unit according to claim 1, wherein the support structure couplers comprise a movably mounted locking element.

4. Transportable machining unit according to claim 1, wherein the support structure couplers include at least one locking anchor contour arranged non-movingly on the support structure.

5. Transportable machining unit according to claim 1, wherein the support structure comprises an upper part removably attached to the lower part and with a frame structure extending vertically upwards over the workpiece support plate.

6. Transportable machining unit according to claim 5, wherein the horizontal cross-section of the upper part has substantially the same outer contour as the horizontal cross-section of the lower part.

7. Transportable machining unit according to claim 5, wherein the tool is attached to the drive unit and is arranged at least partially above the workpiece support plate, and the frame structure extends vertically upwards beyond the tool attached to the drive unit.

8. Transportable machining unit according to claim 5, wherein the upper support structure couplers are provided on the upper part and/or the lower support structure couplers are provided on the lower part.

9. Transportable machining unit according to claim 5, wherein the upper part is designed as a hood-shaped cover which, in a state attached to the support structure, covers the workpiece support plate.

10. Transportable machining unit according to claim 5, wherein the frame structure and the workpiece support surface together define a storage space and the upper part has a removable and/or pivotable cover which is attached to the frame structure and which, in an open position, gives access to the storage space.

11. Transportable machining unit according to claim 1, including a carrying handle is provided on the support structure, wherein the support structure is designed such that the transportable machining unit can be carried with the carrying handle.

12. Stack assembly comprising a transportable machining unit according to claim 1 and at least one box-shaped body arranged on or below the transportable machining unit to form a vertical stack together with the transportable machining unit, wherein the box-shaped body has body couplers cooperating with the support structure couplers to provide a releasable, vertically tension-proof coupling between the box-shaped body and the transportable machining unit.

13. Stack assembly according to claim 12, wherein the box-shaped body is a container.

14. Stack arrangement according to claim 12, wherein the horizontal cross-section of the transportable machining unit has substantially the same outer contour as the horizontal cross-section of the box-shaped body and the transportable machining unit is aligned with the box-shaped body so that the transportable machining unit and the box-shaped body together form a substantially cuboid stack.

15. Stack assembly according to claim 12, wherein the box-shaped body is a further said machining unit.

16. Transportable machining unit according to claim 3, wherein the movably mounted locking element comprises a rotary latch rotatably mounted on the support structure.
